(19) United States
(12) Patent Application Publication
(10) Pub. No.: US 2026/0364972 A1
(43) Pub. Date: Nov. 19, 2026

(54) VEHICLE WHEEL HUB ASSEMBLY

(71) Applicant: WILDERNESS TRAIL BIKES LICENSING, INC., Mill Valley, CA (US)

(72) Inventors: Raphael Schlanger, Wilton, CT (US); Evan Smith, Nevada City, CA (US)

(21) Appl. No.: 19/126,054

(22) PCT Filed: Nov. 1, 2023
(86) PCT No.: PCT/US23/36565

§ 371 Date: Apr. 30, 2025

Related U.S. Application Data
(60) Provisional application No. 63/421,787, filed on Nov. 2, 2022.

(51) Int. Cl. B60B 27/02; B60B 27/00; B60B 27/04

(52) U.S. Cl. CPC B60B 27/023; B60B 27/0031; B60B 27/047

(57) ABSTRACT

A hub assembly, comprising: an axle; a hubshell rotatable about the axle; a bearing assembly including an inner race and outer race; a rotatable driving element; a rotatable driven element; a rotatable coupling at a coupling interface between the driving and driven elements. The driving element is rotatably coupled to the driven element in at least one direction of rotation about said axial axis. The hubshell includes a bearing bore to receive the outer race. The driven element is rotationally keyed to the hubshell at an engagement interface for transmission of torque therebetween. The engagement interface may be arranged to be at least one of: (i) axially overlapping said outer race at a location radially outboard of the bearing bore; or (ii) axially coincident with the outer race at a location radially outboard of the bearing bore. The driven element may be axially abutting the axially outboard end face to limit axially inward displacement of the driven element relative to the hubshell.

### CROSS-REFERENCES

This patent application is the national stage patent application of international patent application no. PCT/US2023/036565 filed on Nov. 1, 2023 and which international patent application no. PCT/US2023/036565 is fully incorporated by reference herein. International patent application no. PCT/US2023/036565 claims the benefit of U.S. Provisional Patent Application No. 63/421,787 by inventor Raphael Schlanger entitled “VEHICLE WHEEL HUB ASSEMBLY,” filed on Nov. 2, 2022, and which Provisional Patent Application is fully incorporated by reference herein.

### BACKGROUND OF THE INVENTION

The present invention relates to a vehicle wheel hub including a torque coupling assembly.

Generally, torque is input to the wheel through a driving element of a hub of the vehicle wheel. The driving element has a torque coupling with a mating driven element of the hub for torque transmission therebetween. Particularly when the vehicle wheel is a bicycle wheel, the torque coupling often includes a one-way clutch, commonly termed a “freewheel” or “ratchet”, that provides motive torque coupling in a driving direction of rotation and freewheeling or uncoupling in the opposite direction of rotation. The driven element is also rotationally coupled to the hub shell such that, in the driving direction, the vehicle wheel is rotated to provide motive force to the vehicle.

The torque coupling between the driven element and the hub shell commonly includes a threaded, a splined and/or a keyed engagement therebetween. Further, the hubshell commonly rotates about a stationary axle, including bearing(s) to facilitate this rotation. Each bearing has an outer race and an inner race as known in industry. The hubshell is commonly supported by two axially spaced bearings, a driveside bearing axially proximal the torque coupling and a nondrive-side bearing axially distal from the torque coupling. It is often desirable to position these bearings as axially outboard as feasible to provide optimal support to the wheel and to allow the wheel to resist lateral loads.

Commonly, the torque coupling will require axial space that restricts and/or limits the axial position of the driveside bearing. To minimize radial loads on the driveside bearing and to minimize stresses and deflection on the axle, it is preferred that the driven element be designed to allow the driveside bearing to be positioned as far axially outboard as possible.

### BACKGROUND

### Discussion of Prior Art

In the case of a torque coupling based on radial pawls, which is the most common torque coupling arrangement, the ratchet ring (i.e. driven element of hub shell) is commonly positioned axially outboard of the outer race of the driveside bearing. The term “driveside” refers to an axially position proximal to the torque coupling. Similarly, in the case of a face-tooth ratchet arrangement, the driven ratchet plate is commonly a spring-biased component whose torque coupling engagement with the hubshell is positioned axially outboard of the outer race of the driveside bearing.

Further, the coupling interface between the driven element and the hubshell commonly includes a threadable connection. Such a threadable connection is problematic because, under heavy driving torque loads, the threadable connection may continue to tighten, creating an effective circumferential slipping of this coupling engagement. In the case of a bicycle hub, this will cause the rider to feel like their pedal is slipping. Further, very high torque loads may eventually cause the threads of the threadable connection to become stripped, thus permanently damaging the hub.

In addition, many prior art hub assemblies do not provide a solid axial locating of the outer race of the driveside bearing within the hubshell. Most often, the outer race is positioned solely by axial abutment between the axially inboard face of this outer race and a mating shoulder of the hubshell. In the case where the driven element radially overlaps this outer race, the axially inboard position of the driven element is limited by an abutment with the hub shell, a component that is discrete from the outer race.

An example prior-art hub design is outlined in U.S. Pat. No. 10,995,806, where FIG. 4 shows the outer race of driveside bearing being radially located within a bearing bore of the driven element. Thus, the driven element is included as an additional third element in the radial stack-up of tolerance error between the bearing and the hubshell, which adversely introduces the potential for additional radial runout error in the rotation of the hubshell. This also necessitates that the driven element includes an axially-extending collar surrounding the bearing bore. This collar must axially overlap the outer race by a large dimension, which adversely results in additional weight.

U.S. Pat. No. 10,995,806 also shows a threadable engagement interface between the driven element and the hub shell. Driving torque is transmitted through this threadable engagement. Firstly, this threadable engagement may threadably tighten due to torque transmission, which provides an undesirable “slipping” sensation to the user, rather than a solid transmission of torque to the hubshell. Secondly, especially since the hubshell is commonly a softer material, such as aluminum, the internal threads of the hubshell can be easily stripped under driving torque, which adversely results in failure of the hub assembly. U.S. Pat. No. 10,995,806 clearly describes (col. 12, lines 54-589) that the shoulder of flange (17) of directly abuts the shoulder (35) of hub shell (2). Because of this, the axial position of the driven element (10) with respect to the hubshell (2) is defined independently of the bearing (14). This means that there is an axial gap between the outer race of bearing and the driven element, which causes the bearing (12) to be positioned further axially inboard by the axial dimension of this gap.

Accordingly, it is an objective of the present invention to overcome the forgoing disadvantages and provide an improved torque coupling assembly, particularly as applied to the hub assembly of a bicycle wheel.

### SUMMARY OF THE INVENTION

### Objects and Advantages

The present invention utilizes a torque coupling assembly wherein the driven element preferably has a spline or keyed engagement with the hubshell. This ensures a solid feel at the pedals and ensures that there will be no circumferential slipping between the driven element and the hubshell. Alternatively, the torque coupling assembly may include a threadable engagement and/or a peg-and-socket engagement with the hubshell, among a variety of other mechanical engagement means.

In general, it is understood that, due to geometry constraints associated with conventional drivetrains, the driveside bearing must be axially positioned at a point further axially inboard than is optimal. As such, the driveside bearing is commonly the most highly loaded bearing of the hub. It is an objective of the present invention to place this bearing as far axially outboard (toward the “drive-side” of the hub assembly) as possible to reduce this radial load and extend the life of this bearing. Additionally, placement of the driveside bearing further axially outboard serves to reduce the stress and deflection of the axle.

The present invention allows the spline engagement to project axially inwardly to a point that is axially inboard of the axially outboard face of the outer race of the driveside bearing. In other words, the spline engagement may axially overlap the outer race of the driveside bearing. This permits the spline engagement to have sufficient axial length of spline engagement overlap to support high torque loads, while also allowing the driveside bearing to be positioned as far axially outboard as possible. This advantageously reduces stress on the driveside bearing, which results in greater durability of this bearing and increased bearing life. This also advantageously reduces stress and deflection of the axle, for reduced lateral deflection of the wheel, which the rider perceives as greater responsiveness and predictability.

Yet further, by reducing stress and deflection of the axle and driveside bearing, the dimensions of the bearing and the axle may be minimized, thus reducing bearing material and reducing the overall weight of the hub.

In addition, the present invention may be configured such that the driven element axially abuts the outer race of the driveside bearing, thus providing precise and accurate positioning of the driven element relative to the bearing. This accurate positioning ensures the optimized functioning of the interface between the driving and driven elements. Furthermore, this axial abutment ensures that there will be no axial free-play between the driven element and the driveside bearing that could otherwise detract from this optimized functioning.

In contrast to the aforementioned U.S. Pat. No. 10,995,806, the present invention shows outer race of driveside bearing being radially located directly within bearing bore of hubshell.

Since there is no third element in this radial stack-up, the potential for additional radial runout error is beneficially reduced.

In contrast to U.S. Pat. No. 10,995,806, the present invention shows a spline engagement interface between driven element and hubshell for transmission of torque. A spline engagement provides a much more robust and solid interface for transmission of torque with no “slipping” and the ability to transmit much higher torque loads than the corresponding threadable interface of U.S. Pat. No. 10,995,806.

In contrast to U.S. Pat. No. 10,995,806, the present invention discloses that the driven element axially abuts the outer race of the driveside bearing and this outer race axially abuts the shoulder of the hub shell. Thus, the bearing is included in the axially abutting stack-up between the driven element and the hubshell to axially sandwich and press the outer race therebetween and there is no gap or clearance in this axial stack-up that would otherwise force this bearing to be positioned further axially inboard. This also serves to position the bearing as close to the driven element as possible, thereby beneficially positioning the bearing as far axially outboard as possible to minimize stress on the bearing, axle sleeve, and hubshell. Also, this abutting stack-up serves to precisely position the driven element relative to the bearing, beneficially increasing the precision of the hub assembly.

Further features of the present invention will become apparent from considering the drawings and ensuing description.

### BRIEF DESCRIPTION OF THE DRAWINGS

The present invention will be more readily understandable from a consideration of the accompanying exemplificative drawings, wherein:

FIG. 1a is a perspective view schematically illustrating the general configuration of a vehicle wheel as applied to a prior-art bicycle wheel.

FIG. 2a is a perspective view of the hub assembly of a first embodiment of the present invention;

FIG. 2b is a cross-section view, taken along 17-17, of the embodiment of FIG. 2a;

FIG. 2c is a perspective exploded perspective view of the embodiment of FIG. 2a, showing the individual components of the hub assembly:

FIG. 2d is a perspective view of the hubshell of the embodiment of FIG. 2a, showing the internal splines;

FIG. 2e is an orthogonal view, taken along 18-18 of the embodiment of FIG. 2a;

FIG. 2f is a cross-section view, taken along 17-17, of the hub shell of the embodiment of FIG. 2a;

FIG. 2g is a perspective view of the driven ratchet plate of the embodiment of FIG. 2a, showing the external splines;

FIG. 2h is a perspective view of the driven ratchet plate of the embodiment of FIG. 2a, showing the face teeth;

FIG. 2i is a cross-section view, taken along 17-17, of the driven ratchet plate of the embodiment of FIG. 2a;

FIGS. 2j-2m describes the successive assembly steps involved in the assembly of the driveside bearing assembly, the driven ratchet plate, and the seal, with the hubshell, of the embodiment of FIG. 2a;

FIG. 2j is a partial cross-section exploded view, taken along 17-17, detailing the assembly of the hubshell, driveside bearing assembly, driven ratchet plate, and seal, prior to the assembly of the driveside bearing with the hubshell;

FIG. 2k is a cross-section exploded view, taken along 17-17, with the driveside bearing assembly first installed in a mating bore of the hubshell;

FIG. 2L is a cross-section exploded view, taken along 17-17, with the driven ratchet plate next installed in the mating hubshell and axially abutting the outer race of the driveside bearing;

FIG. 2m is a cross-section exploded view, taken along 17-17, with the seal next installed in the mating hubshell and axially abutting the driven ratchet plate;

FIG. 3a is a partial exploded perspective view of a second embodiment of the present invention, corresponding to the assembly sequence of FIG. 2j, showing a driven ratchet plate having a peg-and-socket engagement with the hubshell;

FIG. 3b is a perspective view of the driven ratchet plate of the embodiment of FIG. 3a;

FIG. 3c is a partial cross-section view, taken along 22-22, of the assembly of FIG. 3a, showing the driveside bearing and driven ratchet plate assembled to the hubshell;

FIG. 4a is a partial exploded perspective view of a third embodiment of the present invention, corresponding to the assembly sequence of FIG. 2j, showing a driven ratchet plate with both a peg engagement and spline engagement with the hubshell;

FIG. 4b is a perspective view of the driven ratchet plate of the embodiment of FIG. 4a;

FIG. 4c is a partial cross section view, taken along 23-23, of the assembly of the embodiment of FIG. 4a, with the driveside bearing and driven ratchet plate assembled to the hubshell;

FIG. 5a is a partial exploded perspective view of a fourth embodiment of the present invention, corresponding to the assembly sequence of FIG. 2j, showing a driven ratchet plate without a collar and with a spline engagement with the hubshell;

FIG. 5b is a perspective view of the driven ratchet plate of the embodiment of FIG. 5a;

FIG. 5c is a partial cross section view, taken along 24-24, of the assembly of the embodiment of FIG. 5a, with the driveside bearing and driven ratchet plate assembled to the hubshell.

### DETAILED DESCRIPTION OF THE INVENTION

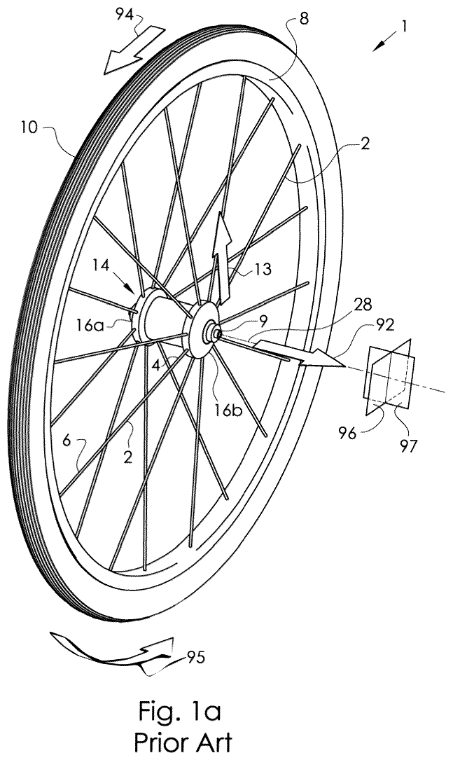

FIG. 1a describes the basic configuration of an exemplary prior art vehicle wheel, in particular, a bicycle wheel 1, as well as a description of the direction conventions used throughout this disclosure. For clarity, the bicycle frame and the quick release skewer assembly are not shown in this figure. The hub shell 14 is rotatable about the axle 9 and includes at least two axially spaced hub flanges 16a and 16b, each of which include a means for connecting with a multiplicity of spokes 2 connected thereto. Axle 9 includes ends 11a and 11b that define the spacing of its mounting with the frame (not shown). The axial axis 28 is the axial centerline of rotation of the bicycle wheel assembly 1. The hub flanges 16a and 16b may be contiguous with the hub shell 14 or may be separately formed and assembled to the hub body 12 portion of the hub shell 14. Each spoke 2 is affixed to its respective hub flange 16a or 16b at its first end 4 and extend to attach the rim 8 at its second ends 6. The tire 10 is fitted to the outer periphery of the rim 8. The wheel of FIG. 1 is generic and may be of tension-spoke or compression-spoke design. The axial direction 92 is any direction parallel with the axial axis 28. The radial direction 93 is a direction generally perpendicular to the axial direction 92 and extending generally from the axial axis 28 radially outwardly toward the rim 8. The tangential direction 94 is a direction generally tangent to the rim at a given radius. The circumferential direction 95 is a cylindrical vector that wraps around the axial axis 28 at a given radius. A radial plane 96 is a plane perpendicular to the axial axis 28 that extends in a generally radial direction at a given axial intercept. An axial plane 97 is a plane that is generally parallel to the axial axis. An orientation that is radially inboard (or inward) is nearer to the axial axis 28 of rotation and a radially outboard (or outward) is further from the axial axis. An axially inboard (or inward) orientation is an orientation that is axially proximal to the axial midpoint between the two ends 11a and 11b. Conversely, an axially outboard (or outward) orientation is an orientation that is axially distal to the axial midpoint between the two ends 11a and 11b. A radially inboard orientation is an orientation that is radially proximal to the axial axis 28 and a radially outboard orientation is an orientation that is radially distal to the axial axis 28. An axially inwardly facing surface is a surface that faces toward the axial midpoint between the two ends 11a and 11b. Conversely, an axially outwardly facing surface is a surface that faces away from the axial midpoint between the two ends 11a and 11b. While it is most common for the hub shell 14 to rotate about a fixed axle 9, there are some cases where it is desirable to permit the axle 9 to be fixed with the wheel 1 such as the case where the wheel 1 is driven by the axle 9.

For the purposes of using conventional terminology, the term “hub flange” is used herein to describe a region of the hub shell 14 to which the spokes 2 are joined. While the surface of the hub flange may be raised and flange-like in comparison to other surfaces of the hub shell 14, this is not a requirement for the present invention and the hub flange 16 may alternatively be flush or recessed relative to other hub shell surfaces.

As is well known in the art, a wheel 1 may be of tension-spoke construction, where the central hub hangs in tension by the spokes from the rim portion directly above, or it may be of compression-spoke construction, where the hub is supported by compressing the spoke directly beneath it. Since the present invention may be directed toward bicycle wheels and since the tension-spoke wheel is generally a more efficient structure than compression-spoke wheel, most of the discussion herein is focused with an eye toward tension-spoke wheel construction. However, it is anticipated that most, if not all, of the embodiments of the present invention may be adapted or otherwise applied to compression-spoke wheel construction as well. For a tension-spoke wheel, it is preferable that the wheel includes at least two hub flanges that are axially spaced on either side of the rim or, more specifically, the spoke attachment points at the rim. Thus the spokes fixed to opposite hub flanges will converge as they extend to the rim. Additionally, a tension-spoke wheel will usually be pre-tensioned during assembly to create a pre-tensioned structure of balanced spoke tension that allows the axle supporting loads to be distributed among several, if not all, of the spokes of the wheel. It is this ability to share the stresses among its spokes that helps to make the tension-spoke wheel the highly efficient structure that it is. For a compression-spoke wheel, it is often preferable to employ at least two axially spaced hub flanges, however, in the case where the spokes have sufficient bending stiffness to support the requisite lateral or side-to-side loads, only a single hub flange may be employed.

The spoke 2 is a generally long slender tensile element with a longitudinal axis 62 along its length and generally parallel to its sidewalls. The spoke 2 also has a tensile axis 61 of applied tensile load 58 that extends along the span portion of the spoke 2 between its anchor points at the rim 8 and hub flange 16. The tensile axis 61 is generally collinear to the longitudinal axis 62, except where the spoke 2 is bent to deviate from the tensile axis 61. For the purposes of definition, as relating to spokes 2 and connections thereto, the term “longitudinal” herein refers to alignment along the longitudinal axis 62. A longitudinally inboard (or inward) orientation refers to an orientation proximal the midpoint of the span portion. Conversely, a longitudinally outboard (or outward) orientation refers to an orientation distal the midpoint of the span portion. The term “lateral” herein refers to an orientation in a direction generally perpendicular to the longitudinal axis 62. A laterally inboard (or inward) orientation refers to an orientation proximal the longitudinal axis. Conversely, a laterally outboard (or outward) orientation refers to an orientation distal the longitudinal axis 62.

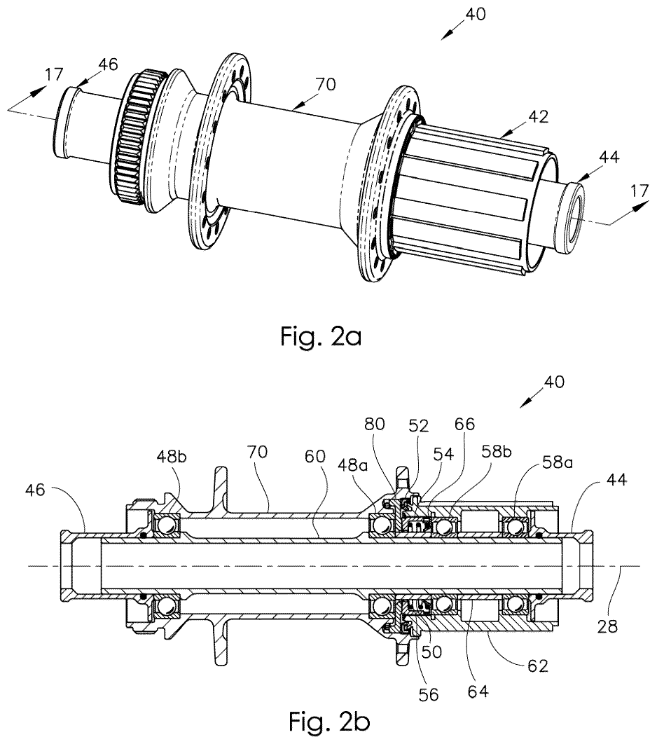

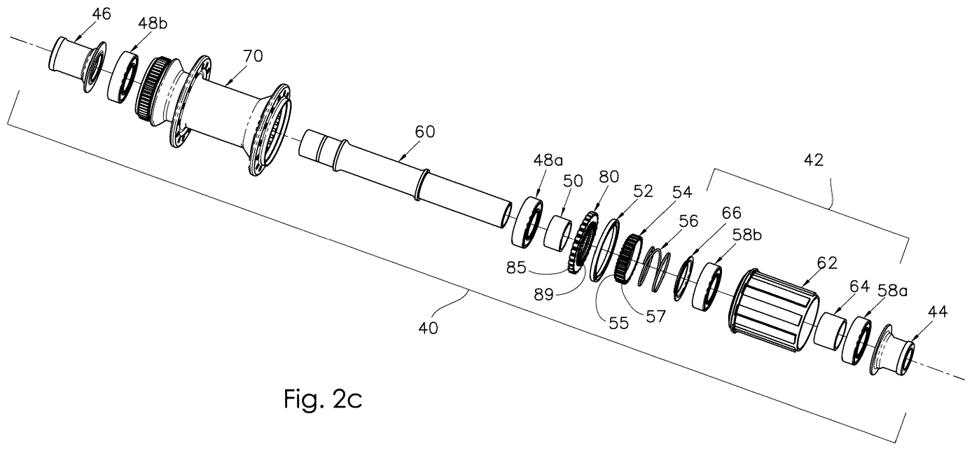

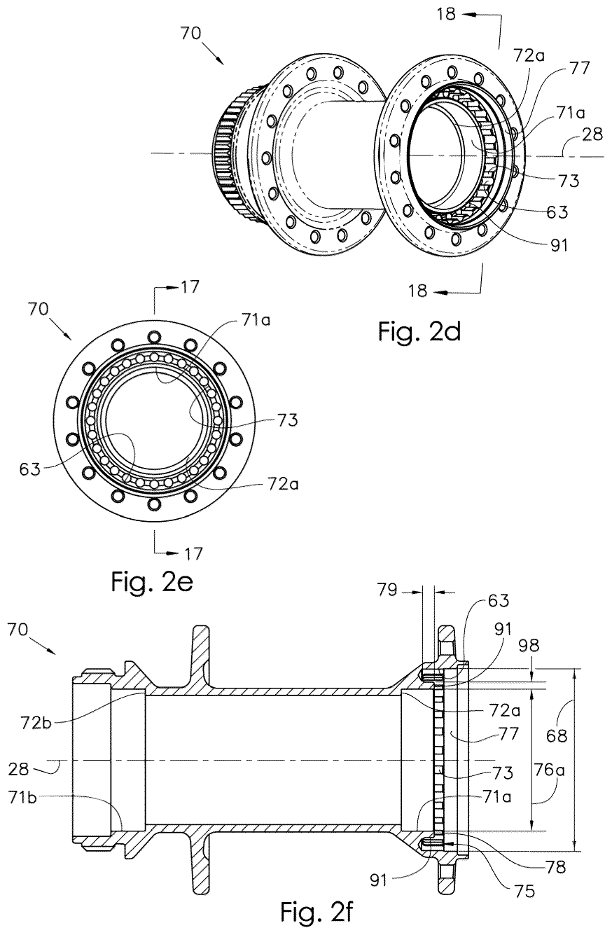

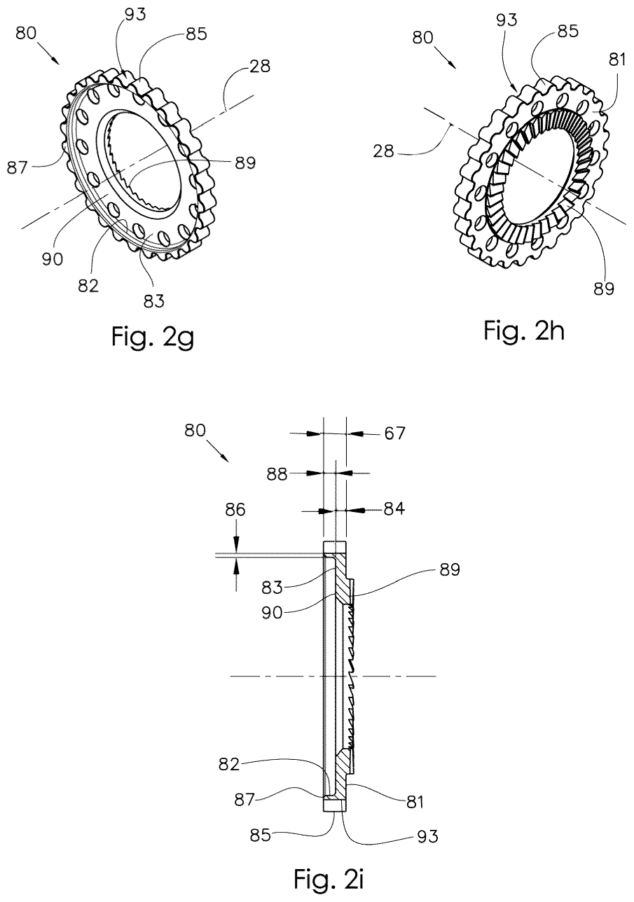

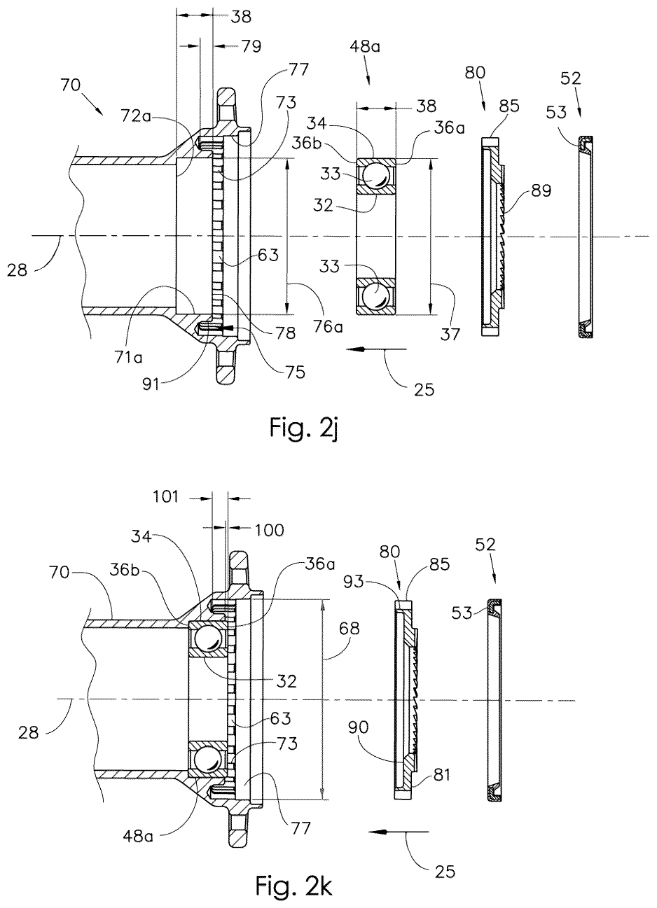

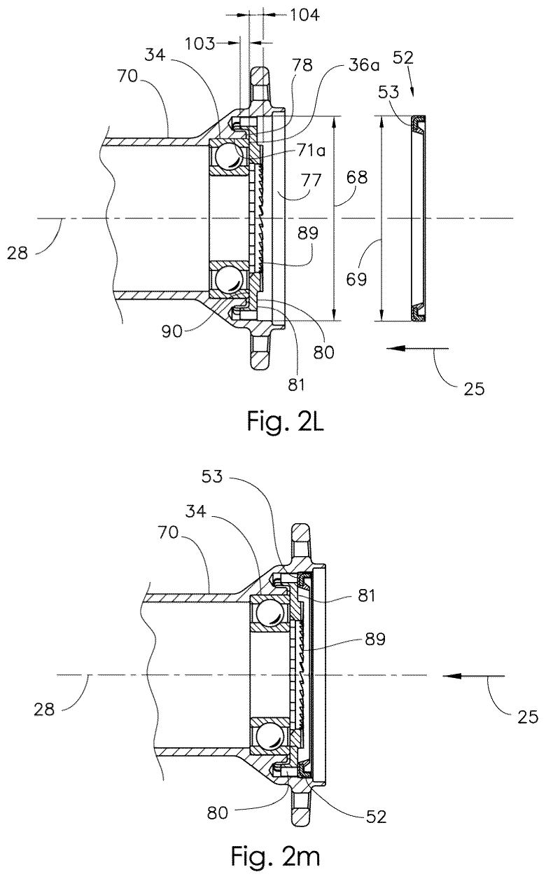

FIGS. 2a-m describe a first embodiment of the present invention where the driven ratchet plate has a spline engagement with the hubshell. FIGS. 2a and 2b show the components of FIG. 2c assembled together to create hub assembly 40. As particularly shown in FIG. 2c, hub assembly 40 includes freehub assembly 42, driveside axlecap 44, nondrive axlecap 46, axle 60, bearings 48a and 48b, spacer 50, seal 52 with back face 53, driving ratchet plate 54, driven ratchet plate 80, and spring 56. Freehub assembly 42 includes spring washer 66 and bearings 58a and 58b pressed into freehub body shell 62 with spacer 64 axially positioned therebetween.

Freehub assembly 42, driveside axlecap 44, nondrive axlecap 46, axle 60, spacer 50, seal 52, driving ratchet plate 54, and spring 56 are all of conventional configuration and function.

Driving ratchet plate 54 includes face teeth 55 for circumferential engagement with face teeth 89 and splines 57 for circumferential engagement with the freehub body shell 62. As is well understood in industry, motive input driving torque is commonly applied to the freehub body shell and is transmitted to the driving ratchet plate 54 by a spline engagement, and from the driving ratchet plate 54 to the driven ratchet plate 80 through engagement between the face teeth 55 and face teeth 89 of the driven ratchet plate 80. This driving torque is then transmitted to the hubshell 70 by a spline engagement between external splines 85 and internal splines 73. Seal 52 serves to restrict intrusion of contaminants within the interface between the hubshell 70 and freehub body shell 62 as is common.

As particularly detailed in FIG. 2b, bearing 48a serves as the driveside bearing to support the hub shell 70. As particularly detailed in FIG. 2j, bearing 48a is constructed as a cartridge bearing assembly, which is known in industry to include: an inner race 32, an outer race 34, and a plurality of balls 33 that serve as rolling elements to permit the outer race 34 to rotate relative to the inner race 32 about the axial axis 28. The outer race 34 has an outside diameter 37 and an axial width 38 between end faces 36a and 36b. Outside diameter 37 is preferably slightly larger than inside diameter 76a of bearing bore 71a to provide an interference or press fit therebetween, as is common. The term bearing bore, as described herein, is a bore to receive the outer race of a bearing assembly. In the case of a plane bearing, the bearing bore may optionally constitute the outer race. While bearing 48a is shown to include rolling elements such as balls 33, a plane bearing arrangement or roller bearing arrangement may be substituted for bearing 48a. With a plane bearing, the outer race slides against the inner race without a rolling element in between. Bearings 48b, 58a, and 58b are also shown here to be of cartridge bearing configuration.

As is conventional, hubshell 70 includes hub flanges 65a and 65b for connection with the spokes (not shown) of the wheel (not shown). Hub shell 70 also includes bearing bores 71a and 71b with shoulders 72a and 72b respectively to receive bearings 48a and 48b as is conventional. Shoulders 72a and 72b provide an axial limit stop for the outer races of respective bearings 48a and 48b. Bearing bore 71a may have an inside diameter 76a that is slightly smaller than outside diameter 37 of outer race 34 to provide an interference or press fit therebetween upon assembly. Bearing bore 71a also has an axial width 38 between shoulder 72a and bore face 78 that is preferably slightly smaller than the axial width 39 of the outer race 34 of bearing 48a. The portion of the hub shell 70 that includes the bearing bore 71a is termed the “bearing housing”. Hub shell 70 also includes a plurality of internal splines 73 or keys that project radially inwardly, having radially outwardly extending gaps or grooves 63 circumferentially positioned between adjacent splines 73, a circumferential relief 75 that projects axially inwardly from bore face 78 by dimension 79, and a seal bore 77 of diameter 68. Housing collar 91 is axially overlapping and radially positioned between relief 75 and bearing bore 71a. The housing thickness 98 corresponds to the radial thickness of hubshell material between the bearing bore 71a and relief 75.

Driven ratchet plate 80 includes a flange portion 83 having an axially inboard face 90, an axially outboard face 81, and an axial thickness 84 therebetween. Flange portion 83 extends radially outwardly to an axially inwardly projecting collar 82 adjacent its radially outward periphery. Collar 82 has a radial thickness 86 and an axially inwardly facing face 87 and projects axially inwardly from face 83 by dimension 88. Face teeth 89 project axially outwardly from flange portion 83 as shown. A plurality of keys or external splines 85 project radially outwardly from the radially outwardly periphery of both the flange 83 and the collar 82 and include radially inwardly projecting grooves or gaps 93 circumferentially positioned between adjacent splines 85. Splines 85 have an axial length 67 that extends axially between outboard face 81 and face 87 to axially overlap both the flange 83 and collar 82. Face teeth 89 of driven ratchet plate are arranged to engage with face teeth 55 of the driving ratchet plate 54 to transmit torque therebetween in the driving direction of rotation about axial axis 28 and to freewheel or slip in the opposite non-driving direction as is understood in industry. Splines 85 of driven ratchet plate 80 are intended to radially overlap and engage with splines 73 of hubshell 70 for transmission of torque therebetween about axial axis 28.

Note that the term “driven ratchet plate” and “driving ratchet plate” describe the more common scenario where the driving ratchet place transmits torque to the driven ratchet plate. This scenario is described herein merely to provide simplicity in description. It is understood that the torque coupling function of these ratchet plates may be transposed and an alternate arrangement may be substituted where the driven ratchet plate 80 shown here is arranged to be functional to serve as a driving element and the driving ratchet plate 54 shown here is arranged to be functional to serve as a driven element such that torque coupling interface therebetween serves to transmit torque from the driven ratchet plate 80 to the driving ratchet plate 54. This alternate arrangement may be applied to all embodiments herein.

The term “spline” or “splines” is commonly understood in industry and is defined as a series of radially outwardly projecting keys or ridges spaced around the circumference of a shaft (i.e. external splines) that mate with radially outwardly projecting grooves (i.e. gaps) that that radially overlap and engage with these keys. These keys project generally radially and are intended to radially overlie each other and mesh to prevent rotational movement between two parts in the conventional manner. Splines commonly extend along a generally axial direction, although splines may alternatively be helical about the axial axis 28. Splines are commonly circumferentially discontinuous, where the ridge or key does not circumscribe the axial axis 28. This spline engagement is in contrast to a thread engagement where a thread ridge commonly wraps helically to fully circumscribe the axial axis 28. As a general rule, splines have the beneficial ability to transmit greater torque than threads. External splines 85 are shown here to have a semi-circular profile that are intended to axially and radially overlap and nest with semi-circular grooves 63 of internal splines 73. Such semi-circular grooves are advantageous because they may be produced in a simple drilling or milling machining operation, which is not possible with non-circular grooves or grooves having sharp corners. Internal splines 73 are intended to axially and radially overlap with grooves or gaps 93 of external splines 85. These radially overlapping engagements permit the transmission of torque between the driven ratchet plate 80 and the hub shell 70.

As shown in FIG. 2k, bearing 48a is pressed into bearing bore 71a in direction 25 and in the conventional manner until the end face 36b contacts shoulder 72a. The end face 36a is slightly proud of bore face 78 by dimension 100 such that relief 75 extends axially inwardly from end face 36a by dimension 101. Next, as shown in FIG. 2L, driven ratchet plate 80 is assembled to hub shell 70 in direction 25 such that splines 85 axially overlap and nest with grooves 63 and splines 73 axially overlap and nest with gaps 93 in a spline engagement therebetween. As such, the end face 36a provides an axially abutting inboard limit stop to the axially abutting face 90 of the driven ratchet plate 80, leaving an axial space between bore face 78 and face 90 corresponding to dimension 100. The collar 82 is also axially overlapping the relief 75 such that the spline engagement between splines 85 and 73 axially overlaps the axial width 39 of outer race 34 and extends to a point axially inboard of end face 36a by dimension 103. Spline engagement between splines 85 and 73 also extends axially outboard of end face 36a by dimension 104, where the axial length of the spline engagement is the sum of dimensions 103 and 104. It is noted that the driven ratchet plate 80 and the torque engagement (between splines 85 and 73) extend to axially inwardly overlap the bearing bore 71a and outer race 34 at an axial position defined by end face 36a. Splines 85 of driven ratchet plate 80 radially overlap and nest with mating grooves 63 and splines 73 are intended to radially overlap and nest with mating gaps 93 such that splines 85 and 73 mesh for transmission of torque therebetween about axial axis 28. The driven ratchet plate 80 and face teeth 89 are positioned to be axially outboard of bearing 48a by distance 104 and are also radially overlapping the bearing 48a and outer race 34. Other embodiments described herein also show this arrangement between the corresponding driven ratchet plate and driveside bearing 48a. It may be preferable to minimize distance 104 such that the bearing may be positioned as far axially outboard as possible.

It is preferred that the face 90 abuts end face 36a such that a small clearance (dimension 100) exists between face 90 and bore face 78. This ensures that there is a solid axial stack-up between the driven ratchet plate 80 and outer race 34 without interference from any portion of the hubshell 70. This eliminates any possibility of axial freeplay of the outer race 34 between the shoulder 72a and the face 90. This also ensures that the axial position of the driven ratchet plate 80 is as close to the bearing 48a as possible, which correspondingly and advantageously allows the bearing 48 to be positioned as far axially outward as possible. Note also that housing collar 91 is axially overlapping collar 82 and is radially positioned between the outer race 34 and collar 82. This permits the outer race 34 to be directly engaged and positioned within the bearing bore 71a for optimal concentricity and accuracy therebetween.

Finally, as shown in FIG. 2m, the seal 52 is pressed into seal bore 77 in direction 25 in the conventional manner until the back face 53 contacts outboard face 81. As there is commonly a an interference press fit between diameters 68 and 69, when the seal 52 is pressed into seal bore 77, the seal 52 is frictionally retained to its mating seal bore 77, which also serves as a retaining means to retain and restrict axially outward displacement of the driven ratchet plate 80. Another method to retain and restrict axially outward displacement of the driven ratchet plate 80 is to maintain an interference press fit at the engagement between the splines 85 and grooves 63 and/or between splines 73 and gaps 93. Alternatively or additionally, a wide range of retaining means known in industry may be utilized to retain and restrict axially outward displacement of the driven ratchet plate 80. Some example alternate retaining means include a snapring (not shown) engaged with a mating groove (not shown) of the hub shell 70 or a threaded ring (not shown) engaged to threads (not shown) of the hub shell 70, among others.

The axial overlap of the spline engagement by dimension 103 provides significant advantage over the prior art since it allows that: (i) the axial width of the spline engagement between splines 85 and 73 may be increased and maximized for sufficient transmission of high rotational torque loads therebetween about the axial axis; and (ii) that the axial distance 102 between the end face 36a and the face teeth 89 is minimized, with only the thickness 84 of the flange 83 therebetween. Since end face 36a is slightly proud of bore face 78, there may be a slight axial clearance between bore face 78 and inboard face 90 to ensure that the axially inboard limit of the driven ratchet plate 80 is provided by an abutment with the outer race 34 34 and that the hub shell 70 does not impede this abutment.

This axial distance 102 is further minimized by designing this assembly such that face 90 axially abuts end face 36a. This axial abutment provides the closest possible axial distance between the end face 36a and the face teeth 89. For example, in an alternate arrangement where the driven ratchet plate axially abuts a portion of the hubshell (i.e. the hubshell provides the axially inboard limit stop to the driven ratchet plate), there would remain an axial gap distance between the end face 36a and the face 90 of driven ratchet plate 80. This axial distance would effectively move the driven ratchet plate axially outwardly, thus increasing the axial distance 102 by this axial gap distance. Still further, with conventional cartridge bearing assemblies, the end face 36a is a flat ground steel surface, which may be an ideal and precise surface to provide for matched contact with the face 90 and to provide for the precise axial location of the driven ratchet plate 80.

Due to the requisite axial width constraint of the freehub assembly, the bearing 48a is commonly subject to very high radial load in use. This requires that the bearing 48a be of a large size to withstand this load and have sufficient longevity, which increases the weight and rotational friction of the hub assembly. Further, this requisite axial width increases the radial load on the axle 60, requiring that the axle 60 be larger and/or thicker and/or made of a denser material (such as heavier steel instead of lighter aluminum) to withstand this radial load and also to reduce unwanted flex and deflection of the axle 60.

By minimizing the axial distance 102, as provided by FIGS. 2a-m, the bearing 48a may be positioned axially outwardly as far as possible. This serves to reduce the radial load experienced by both the bearing 48a and axle 60. This reduces the flex and deflection of the axle 60. This also minimizes the size and weight of bearing 48a and/or increases its longevity. Axle 60 may also be made thinner and/or of lighter material and/or of smaller diameter. The result is a hub assembly 20 that has excellent longevity and durability, and is as light and cost effective as possible.

It is noted that the hub assembly 40 shows a ratcheting engagement interface between face teeth 55 and 89 where the driven ratchet plate 80 is axially fixed to the hubshell 70. The driving ratchet plate 54 is axially “floating” and may be axially displaced within the freehub body shell 62 while still maintaining the circumferential engagement therebetween (by splines 57). The spring 56 serves to bias the face teeth 55 against the face teeth 89 such that, in the freewheeling direction of rotation therebetween, the face teeth 55 and 89 cam against each other to axially displace the driven ratchet plate 54 and compress spring 56. This schematic arrangement is known in industry.

FIGS. 2a-m describe an arrangement where the driven ratchet plate 80 is axially fixed relative to the hub shell 70. Alternatively, the arrangement of FIGS. 2a-m may be adapted to an arrangement wherein the driven ratchet plate may instead be axially displaceable relative to the hubshell 70. The engagement interface between splines 73 and 85 will still serve to limit circumferential displacement between the driven ratchet plate and the hubshell. As a further alternative arrangement, the driving ratchet plate may be axially fixed to the freehub body shell 62. In a still further alternate arrangement, driving torque may be transmitted between driving and driven ratchet plates in both directions of rotation, without over-running or freewheeling therebetween. In a yet further alternate arrangement, an intermediate engagement element may be inserted between the driving and driven ratchet plates such that driving torque may be transmitted between the driving ratchet plate and the intermediate engagement element and also transmitted between the intermediate engagement element and the driven ratchet plate.

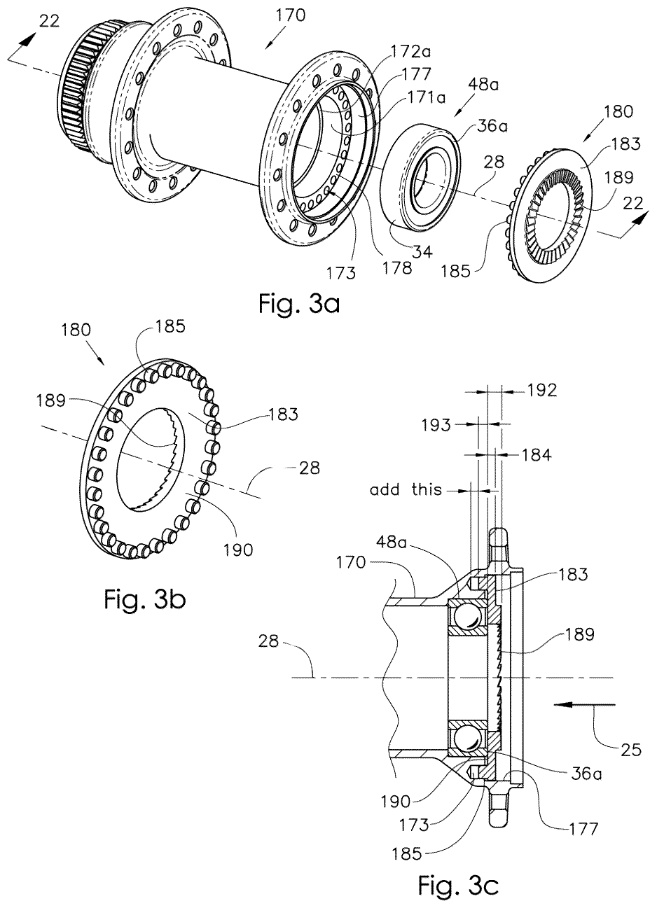

The embodiment of FIGS. 3a-c details an arrangement identical to the embodiment of FIGS. 2a-m, with the exception that the torque coupling engagement between the driven ratchet plate and the hub shell is a peg-and-socket engagement in place of the spline engagement of FIGS. 2a-m. Hub shell 170 and driven ratchet plate 180 are intended to replace hub shell 70 and driven ratchet plate 80 of FIGS. 2a-m. Hub shell 170 is of generally conventional configuration and includes bearing bore 171a with shoulder 172a respectively and a bore face 178. Hub shell 170 also includes holes or sockets 173 that project axially inwardly from bore face 178, and a seal bore 177 to receive a seal 52 (not shown) as previously described in FIG. 2m. Bearing 48a is identical to that described in FIGS. 2a-m.

Driven ratchet plate 180 includes a flange portion 183 having an axially inboard face 190 and an axial thickness 184. Face teeth 189 project axially outwardly from flange portion 183 as shown. Pegs 185 project axially inwardly from the axially inboard face 190 and extend to axially overlap and engage the sockets 173 of the hubshell 170. Face teeth 189 of driven ratchet plate 180 are arranged to engage with face teeth 55 of the driving ratchet plate 54 to transmit torque therebetween in the driving direction of rotation about axial axis 28 and to freewheel or slip or over-run in the opposite non-driving direction as is understood in industry. Pegs 185 of driven ratchet plate 180 are intended to mate and engage with sockets 173 of hubshell 170 for transmission of torque therebetween about axial axis 28.

As shown in FIG. 3c, bearing 48a is pressed into bearing bore 171a in direction 25 and in the conventional manner until the end face 36b contacts shoulder 172a. The end face 36a is slightly axially proud of bore face 178. Next, driven ratchet plate 180 is assembled to hub shell 170 in direction 25 such that pegs 185 are axially nested and engaged within sockets 173 and face 190 axially abuts end face 36a. As such, the end face 36a provides an axially inboard limit stop to the driven ratchet plate 180. Pegs 185 are now extending axially inboard of face 36a by distance 193 such that the axially overlapping peg-and-socket engagement between pegs 185 and sockets 173 also axially overlaps the axial width 35 of outer race and extends to a point axially inboard of end face 36a. Pegs 185 also extend axially inboard of bore face 178 to axially overlap respective sockets 173 to provide engagement and torque coupling with the hubshell 170. It is noted that the driven ratchet plate 180 and the torque engagement (between pegs 185 and sockets 173) extend to axially inwardly overlap the bearing bore 171a and the outer race 34 at a position radially outboard of bearing bore 171a.

The aforementioned axial overlap of the peg-and-socket engagement provides similar advantage over the prior art to the advantage described in FIGS. 2a-m where: (i) the axial width of the peg-and-socket may be maximized and sufficient for transmission of high rotational torque loads therebetween about the axial axis 28; and (ii) the axial distance 192 between the end face 36a and the face teeth 189 is minimized, with only the thickness 184 of the flange 183 therebetween. Further, the axial abutment between faces 36a and 190 provides the closest possible axial distance between the end face 36a of bearing 48a and the face teeth 189. Similar to the embodiment of FIGS. 2a-m, the result is a hub assembly 20 that has excellent longevity and durability, and is as light and cost effective as possible. A seal 52 (not shown) may next be pressed into seal bore 177 to retain and restrict axially outward displacement of the driven ratchet plate 180 in the manner described in FIGS. 2a-m. Since end face 36a is slightly proud of face 178, there may be a slight axial clearance between face 178 and inboard face 190 to ensure that the axially inboard limit stop of the driven ratchet plate 180 is provided by an abutment with the outer race 34 and not with the hub shell 170.

The collar 82 of FIGS. 2a-m serves as a circumferential web to axially overlap and circumferentially connect adjacent keys or external splines 85. Similarly, hub shell 70 material serves as a circumferential web to axially overlap and circumferentially connect adjacent keys or internal splines 73. In contrast, pegs 185 may be considered as circumferentially spaced keys having circumferential gaps therebetween, without an axially overlapping bridge (such as collar 82 of FIGS. 2a-m) connecting them. Also, sockets 173 preferably surround and enclose these pegs 185 upon assembly therebetween.

In an alternate peg-and socket arrangement, the pegs 185 and sockets 173 may be transposed such that the hub shell may include axially outwardly projecting pegs and the driven ratchet plate may include axial sockets. The alternate pegs are mated and engaged with the alternate sockets for transmission of torque therebetween about axial axis 28.

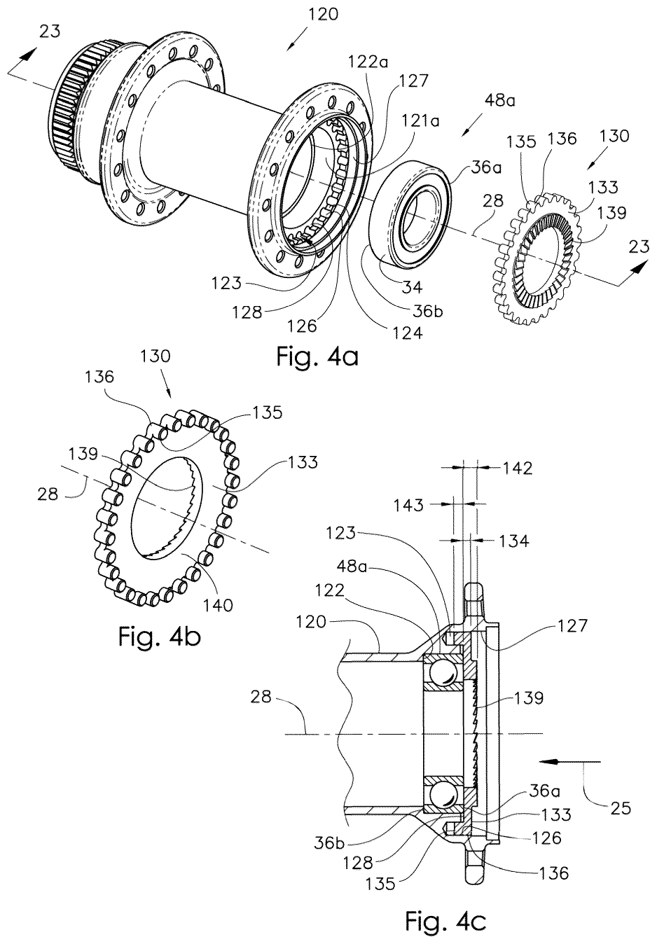

The embodiment of FIGS. 4a-c details an arrangement having similarity to the embodiments of both FIGS. 2a-m and FIG. 3a-c where the torque coupling between the driven ratchet plate 130 and hubshell 120 includes both a spline engagement and a peg-and-socket engagement. Hub shell 120 and driven ratchet plate 130 are intended to replace hub shell 70 and driven ratchet plate 80 of FIGS. 2a-m. Hub shell 120 is of generally conventional configuration and includes bearing bore 121a with shoulder 122a respectively. Hub shell 120 also includes splines 124 with grooves or gaps 126 circumferentially positioned between adjacent splines 124. Hub shell 120 also includes sockets 123 that project axially inwardly from end face 128 of bore 121a, and a seal bore 127 to receive a seal 52 (not shown) in an arrangement previously described in FIG. 2m. Sockets 123 are shown to be circumferentially aligned with the gaps 126 between adjacent splines 123. Bearing 48a is identical to that described in FIGS. 2a-m.

Driven ratchet plate 130 includes a flange portion 133 having an axially inboard face 140 and an axial thickness 134. Face teeth 139 are similar to face teeth 89 of FIGS. 2a-m and project axially outwardly from flange portion 133 as shown. Splines 136 project radially outwardly from the radially outward periphery of the flange 133 and extend axially to overlap the flange portion 133. Pegs 135 are shown to be axial extensions of splines 136 that are also axially collinear with splines 136. Thus, the radially outward periphery of pegs 135 are continuous with respective splines 136.

As shown in FIG. 4c, bearing 48a is pressed into bearing bore 121a in direction 25 and in the conventional manner until the end face 36b contacts shoulder 122a. The end face 36a is slightly proud of end face 128. Next, driven ratchet plate 130 is assembled to hub shell 120 in direction 25 such that pegs 135 are nested and engaged within sockets 123, splines 136 are overlapping and engaged to mating splines 124, and face 140 axially abuts end face 36a. As such, the end face 36a provides an axially inboard limit stop to the driven ratchet plate 130. Pegs 135 are now extending axially inboard of face 36a by distance 143 such that the peg-and-socket engagement between pegs 185 and sockets 123 axially overlaps the axial width 35 of outer race 34 and extends to a point axially inboard of end face 36a. Pegs 135 also extend axially inboard of face 128 to axially overlap respective sockets 123 to provide engagement and torque coupling with the hubshell 120. Further, splines 136 also extend axially outboard of face 128 to engage with gaps 126 and axially overlap respective splines 124 to provide additional engagement and torque coupling with the hubshell 120.

As shown in FIG. 4c, pegs 135 project axially inwardly from the axially inboard face 140 and extend to axially overlap nest in their mating sockets 123 of the hubshell 120 at a location radially outboard of bearing bore 121 and of outer race 34. Face teeth 139 of driven ratchet plate 130 are arranged to engage with face teeth 55 of the driving ratchet plate 54 to transmit torque therebetween in the driving direction of rotation about axial axis 28 and to freewheel or slip in the opposite non-driving direction as is known in industry. Pegs 135 of driven ratchet plate 130 are intended to mate and engage with sockets 123 of hubshell 120 for transmission of torque therebetween about axial axis 28. Similarly, splines 136 of driven ratchet plate 130 are intended to radially overlap with mating gaps 126 to engage with mating splines 124 of hubshell 120 for transmission of torque therebetween about axial axis 28. A seal 52 (not shown) may next be pressed into seal bore 127 to retain and restrict axially outward displacement of the driven ratchet plate 130 in the manner described in FIGS. 2a-m.

The aforementioned axial overlap of both the spline engagement and the peg-and-socket engagement provides similar advantage over the prior art to the advantage described in FIGS. 2a-m where: (i) the axial width of the peg-and-socket may be maximized and sufficient for transmission of high rotational torque loads therebetween about the axial axis 28; and (ii) the axial distance 142 between the end face 36a and the face teeth 139 is minimized, with only the thickness 134 of the flange 133 therebetween. Further, the axial abutment between faces 36a and 140 provides the closest possible axial distance between the end face 36a of bearing 48a and the face teeth 139. As previously described, this results in a hub assembly 20 that has excellent longevity and durability, and is as light and cost effective as possible. Since end face 36a is slightly proud of face 128, there may be a slight axial clearance between face 128 and inboard face 140 to ensure that the axially inboard limit of the driven ratchet plate 130 is provided by an abutment with the outer race 34 and that the hub shell 120 does not impede this abutment.

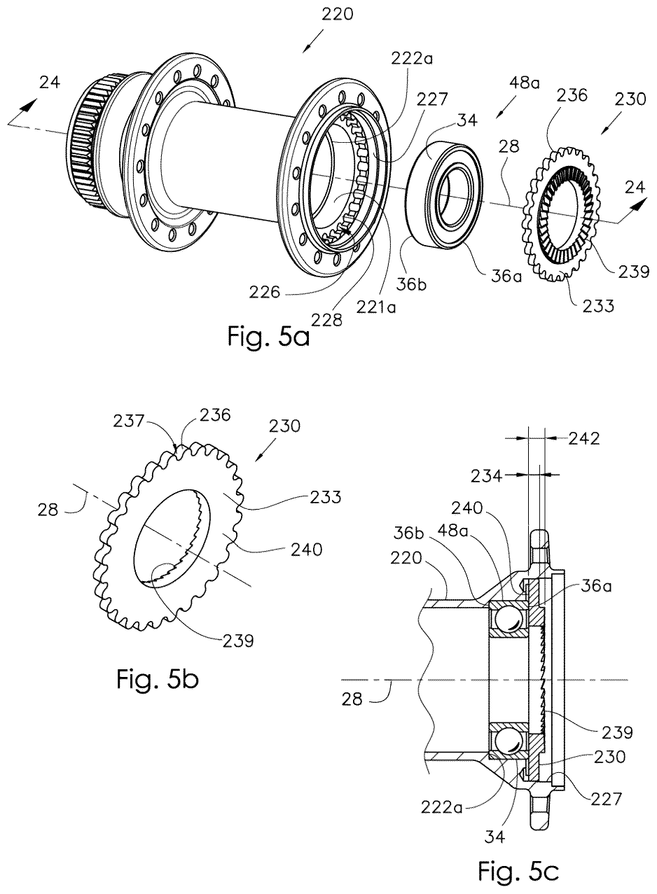

The embodiment of FIGS. 5a-c details an arrangement having similarity to the embodiment of FIGS. 2a-m, with the exception that the ratchet plate 230 does not include the collar 82. Hub shell 220 and driven ratchet plate 230 are intended to replace hub shell 70 and driven ratchet plate 80 of FIGS. 2a-m. Hub shell 220 is of generally conventional configuration and includes bearing bore 221a with shoulder 222a respectively. Hub shell 220 also includes splines 224 with grooves or gaps 226 circumferentially positioned between adjacent splines 224. Hub shell 120 also includes a seal bore 227 to receive a seal 52 (not shown) in an arrangement previously described in FIG. 2m. Bearing 48a is identical to that described in FIGS. 2a-m.

Driven ratchet plate 230 includes a flange portion 233 having an axially inboard face 240 and an axial thickness 234. Face teeth 239 are similar to face teeth 89 of FIGS. 2a-m and project axially outwardly from flange portion 233 as shown. Splines 236 project radially outwardly from the radially outward periphery of the flange 233, with notches or gaps 237 between adjacent splines 236.

As shown in FIG. 5c, bearing 48a is pressed into bearing bore 221a in direction 25 and in the conventional manner until the end face 36b contacts shoulder 222a. The end face 36a is slightly proud of end face 228. Next, driven ratchet plate 230 is assembled to hub shell 220 in direction 25 such that splines 236 are overlapping and engaged to mating splines 224, and face 240 axially abuts end face 36a. As such, the end face 36a provides an axially inboard limit stop to the driven ratchet plate 230. Splines 236 of driven ratchet plate 230 radially overlap and nest with mating gaps 226 and splines 224 are intended to radially overlap and nest with mating gaps 237 such that splines 224 and 236 mesh for transmission of torque therebetween about axial axis 28.

Face teeth 239 of driven ratchet plate 230 are arranged to engage with face teeth 55 of the driving ratchet plate 54 to transmit torque therebetween in the driving direction of rotation about axial axis 28 and to freewheel or slip in the opposite non-driving direction as is known in industry. A seal 52 (not shown) may next be pressed into seal bore 227 to retain and restrict axially outward displacement of the driven ratchet plate 230 in the manner described in FIGS. 2a-m.

The aforementioned axial overlap of the torque coupling engagement between splines 236 and 224 provides similar advantage over the prior art to the advantage described in FIGS. 2a-m where: (i) the axial width this spline engagement may be maximized and sufficient for transmission of high rotational torque loads therebetween about the axial axis 28; and (ii) that the axial distance 242 between the end face 36a and the face teeth 239 is minimized, with only the thickness 234 of the flange 233 therebetween. Further, the axial abutment between faces 36a and 240 provides the closest possible axial distance between the end face 36a of bearing 48a and the face teeth 139. As previously described, this results in a hub assembly 20 that has excellent longevity and durability, and is as light and cost effective as possible. Since end face 36a is slightly proud of end face 228, there may be a slight axial clearance between end face 228 and inboard face 240 to ensure that the axially inboard limit of the driven ratchet plate 230 is provided by an abutment with the outer race 34 and that the hub shell 220 does not impede this abutment.

While my above description contains many specificities, these should not be construed as limitations on the scope of the invention, but as merely providing exemplary illustrations of some of the preferred embodiments of this invention.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications that are within its spirit and scope as defined by the claims.

1. A vehicle wheel hub assembly, comprising:
an axle that is rotationally stationary about an axial axis;
a hubshell that is rotatable about said axle and about said axial axis;
a bearing assembly to facilitate said rotation of said hubshell, said bearing assembly including an inner race rotationally fixed to said axle and an outer race rotationally fixed to said hubshell;
a driving element rotatable about said axial axis;
a driven element rotatable about said axle and said axial axis;
a rotatable coupling at a coupling interface between said driving element and said driven element, wherein said driving element is rotatably coupled to said driven element in at least one direction of rotation about said axial axis;
wherein said hubshell includes a bearing bore to receive and to axially overlap said outer race therein;
wherein said driven element is rotationally keyed to said hubshell at an engagement interface for transmission of torque therebetween;
wherein said engagement interface is arranged to be at least one of: (i) axially overlapping said outer race at a location radially outboard of said bearing bore; or (ii) axially coincident with said outer race at a location radially outboard of said bearing bore; and
wherein said driven element extends radially inboard of said bearing bore.

2. The vehicle wheel hub assembly according to claim 1, wherein said engagement interface is arranged to be axially overlapping at least one of said outer race and said bearing bone in an axial overlap region.

3. (canceled)

4. The vehicle wheel hub assembly according to claim 2, including a radial space between said driven element and said bearing bore, wherein said hubshell axially overlaps both said bearing bore and said driven element within said radial space.

5. The vehicle wheel hub assembly according to claim 2, wherein said engagement interface is directly between said driven element and said hubshell.

6. (canceled)

7. The vehicle wheel hub assembly according to claim 1, wherein said outer race includes an axially outboard end face and said driven element is axially abutting said axially outboard end face.

8. The vehicle wheel hub assembly according to claim 1, wherein said rotatable coupling includes at least one face tooth of said driving element axially overlapping and rotatably engaged to at least one face tooth of said driven element.

9. (canceled)

10. (canceled)

11. (canceled)

12. The vehicle wheel hub assembly according to claim 2, wherein said driven element includes an axially inwardly projecting collar that axially overlaps said outer race of said bearing.

13. The vehicle wheel hub assembly according to claim 2, wherein said hubshell includes a circumferential relief radially outboard of said bearing bore and axially overlapping said outer race and wherein said driven element includes an axially inwardly projecting-collar that axially overlaps said circumferential relief.

14. The vehicle wheel hub assembly according to claim 13, wherein said circumferential relief includes a spline groove and wherein said collar includes a spline key to engage said spline groove.

15. The vehicle wheel hub assembly according to claim 1, wherein said driven element includes a spline key to engage a mating spline groove of said hubshell in a spline engagement for transmission of torque therebetween.

16. The vehicle wheel hub assembly according to claim 15, wherein said spline key is of an external spline and said spline groove is of an internal spline of said hubshell.

17. (canceled)

18. The vehicle wheel hub assembly according to claim 2, wherein said bearing bore includes an axially outboard end face and wherein said driven element is axially outwardly spaced from said end face of said bearing bore, including an axial clearance gap therebetween.

19. The vehicle wheel hub assembly according to claim 12, wherein said hubshall includes a bearing housing circumferentially surrounding at least a portion of said bearing bore and where said collar is radially outboard and axially overlapping said bearing housing.

20. The vehicle wheel hub assembly according to claim 2, wherein said driven element includes an axially inwardly projecting peg that axially overlaps an axially inwardly recessed socket of said hubshell.

21. The vehicle wheel hub assembly according to claim 2, wherein both: (i) said driven element includes a spline key to engage a mating spline groove of said hubshell; and (ii) said driven element includes an axially inwardly projecting peg that axially overlaps an axially inwardly recessed socket of said hubshell.

22. (canceled)

23. The vehicle wheel hub assembly according to claim 15, wherein said hubshell includes a plurality of said spline grooves that are circumferentially spaced and said driven element includes a plurality of said spline keys that are circumferentially spaced, and wherein said engagement interface is between said plurality of said spline grooves and said plurality of said spline keys for transmission of torque therebetween.

24. (canceled)

25. The vehicle wheel hub assembly according to claim 15, wherein said spline groove includes a semi-circular cylindrical profile as viewed along said axial axis.

26. The vehicle wheel hub assembly according to claim 15, wherein said spline key includes a semi-circular cylindrical profile as viewed along said axial axis.

27. The vehicle wheel hub assembly according to claim 15, wherein said spline engagement extends axially outwardly from said outer race.

28. The vehicle wheel hub assembly according to claim 1, including a retaining element, said retaining element serving to restrict axially outward displacement of said driven element relative to said hubshell.

29. The vehicle wheel hub assembly according to claim 28, wherein said retaining element is a seal, said seal also serving to provide sealing to restrict contaminants from entry between said driving element and said driven element.

30. The vehicle wheel hub assembly according to claim 1, including an interference fit between said driven element and said hubshell, said interference fit serving to restrain axially outward displacement of said driven element relative to said hubshell.

31. (canceled)

32. The vehicle wheel hub assembly according to claim 7, wherein said driven element is directly axially abutting said end face.

33. The vehicle wheel hub assembly according to claim 7, wherein said end face is axially outboard of said bearing bore.

34. The vehicle wheel hub assembly according to claim 7, wherein said bearing bore includes an axially outboard end face and wherein said driven element is axially outwardly spaced from said end face of said bearing bore, including an axial clearance gap therebetween.

35. (canceled)

36. (canceled)

37. The vehicle wheel hub assembly according to claim 7, wherein bearing bore includes a shoulder to provide an axial limit stop for axial location of said outer race, and wherein said outer race is axially sandwiched between said shoulder and said driven element.

38. (canceled)

39. (canceled)
